(19) United States
(12) Patent Application Publication
(10) Pub. No.: US 2021/0295473 A1
(43) Pub. Date: Sep. 23, 2021

(54) METHOD FOR IMAGE RESTORATION, ELECTRONIC DEVICE, AND STORAGE MEDIUM

(71) Applicant: BEIJING SENSETIME TECHNOLOGY DEVELOPMENT CO., LTD., Beijing (CN)

(72) Inventors: Ke YU, Beijing (CN); Xintao WANG, Beijing (CN); Chao DONG, Beijing (CN); Xiaoou TANG, Beijing (CN); Chen Change LOY, Beijing (CN)

(73) Assignee: BEIJING SENSETIME TECHNOLOGY DEVELOPMENT CO., LTD., Beijing (CN)

(21) Appl. No.: 17/341,607

(22) Filed: Jun. 8, 2021

Related U.S. Application Data
(63) Continuation of application No. PCT/CN2019/083855, filed on Apr. 23, 2019.

(30) Foreign Application Priority Data
Feb. 15, 2019 (CN) 201910117782.X

(51) Int. Cl. G06T 5/00

(52) U.S. Cl. CPC G06T 5/001; G06T 2207/20081; G06T 2207/20084; G06T 2207/20021

(57) ABSTRACT

A method for image restoration, an electronic device and a computer storage medium are provided. The method includes that: region division is performed on an acquired image to obtain more than one sub-image; each sub-image is input into multiple paths of neural network and restored by using a restoration network determined for each sub-image; a restored image of each sub-image is output and obtained, so as to obtain a restored image of the acquired image.

### CROSS-REFERENCE TO RELATED APPLICATIONS

The application is a continuation of International Patent Application No. PCT/CN2019/083855 filed on Apr. 23, 2019, which claims priority to Chinese Patent Application No. 201910117782.X filed on Feb. 15, 2019. The disclosure of these applications is hereby incorporated by reference in their entirety.

### BACKGROUND

Image restoration is a process that degraded images are reconstructed or restored by means of computers. There are many reasons for degradation of the images, for example, distortions caused by noise exposure and on-blur obscureness of cameras, image compression and so on. The image restoration process in reality is very complicated, because the degradation process of the images may include a variety of distortions at different degrees, and the distortions vary from each other in type and degree between different images and even are not uniformly distributed in the same image. For instance, the exposure noise is large in dark portions of an image, while small in bright portions of the image.

As a matter of fact, different image regions vary from each other in contents and distortions, which causes that some image regions may be restored in a simpler manner. For example, the sky background in the image has a simple texture and a high brightness, such that the noise included is relatively small, and thus these regions can be easily restored. However, concerning the non-uniform distribution of the contents and distortions of the image, some simple regions are also subjected to complex calculation, resulting in a slow speed of image restoration.

### SUMMARY

Embodiments of the present disclosure relate to the technical field of image restoration, and relate to, but are not limited to a method and apparatus for image restoration, an electronic device and a storage medium.

An embodiment of the present disclosure provides a method for image restoration, which may include the following operations. Region division is performed on an acquired image to obtain at least one sub-image; and each of the at least one sub-image is input to a multi-path neural network, and each sub-image is restored by using a restoration network determined for each sub-image to obtain and output a restored image of each sub-image. A restored image of the acquired image is obtained based on the restored image of each sub-image.

An embodiment of the present disclosure provides an apparatus for image restoration, which may include: a division module and a restoration module. The division module is configured to perform region division on an acquired image to obtain at least one sub-image. The restoration module is configured to input each of the at least one sub-image to a multi-path neural network, and restore each sub-image by using a restoration network determined for each sub-image to obtain and output a restored image of each sub-image, and obtain a restored image of the acquired image based on the restored image of each sub-image.

An embodiment of the present disclosure provides an electronic device, which may include: a processor, a memory and a communication bus. The communication bus is configured to implement connection and communication between the processor and the memory; and the processor is configured to execute an image restoration program stored in the memory to implement the method for image restoration as described above.

The present disclosure provides a computer readable storage medium, which stores one or more programs; where the one or more programs may be executed by one or more processors to implement the method for image restoration as described above.

### BRIEF DESCRIPTION OF THE DRAWINGS

FIG. 1 is a flowchart schematic diagram of a method for image restoration according to an embodiment of the present disclosure.

FIG. 2 is a flowchart schematic diagram of another method for image restoration according to an embodiment of the present disclosure.

FIG. 3 is a structural schematic diagram of an optional multi-path neutral network according to an embodiment of the present disclosure.

FIG. 4 is a structural schematic diagram of an optional dynamic block according to an embodiment of the present disclosure.

FIG. 5 is a structural schematic diagram of another optional dynamic block according to an embodiment of the present disclosure.

FIG. 6 is a structural schematic diagram of an apparatus for image restoration according to an embodiment of the present disclosure.

FIG. 7 is a structural schematic diagram of an electronic device according to an embodiment of the present disclosure.

### DETAILED DESCRIPTION

To make the objectives, technical solutions, and advantages of the present disclosure clearer, the specific technical solutions of the present disclosure are described below in detail with reference to the accompanying drawings in the embodiments of the present disclosure. The following embodiments are used for illustrating the present disclosure, but are not to limit the scope of the present disclosure.

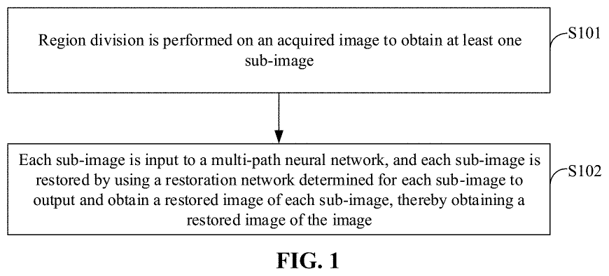

An embodiment of the present disclosure provides a method for image restoration. FIG. 1 is a flowchart schematic diagram of a method for image restoration provided by an embodiment of the present disclosure. The method steps may be implemented by a computer. As shown in FIG. 1, the method for image restoration may include the following operations.

In S101, region division is performed on an acquired image to obtain at least one sub-image.

At present, due to distortions of images caused by noise exposure and on-blur obscureness of cameras, image compression and so on, restoration of the images is necessary. However, since the degradation process of the images may have a variety of distortions with different degrees, and a type and degree of distortion vary from each other between different images. As a result, if all regions of each image are subjected to the same processing through a very deep neutral network, the speed of image restoration will be affected.

In order to improve the speed of image restoration, after an image is acquired, the region division is first performed on the image to obtain at least one sub-image.

In actual applications, if an image having a resolution of 63*63 is acquired, the image is divided into multiple regions, each of which is the above sub-image. Each sub-image overlaps with a neighboring image at 10 pixels in a horizontal abscissa direction and a vertical ordinate direction. After each sub-image is restored through a multi-path neutral network, the restored sub-images are spliced into an integrated image; and overlapping regions are averaged, so that the restored image can be obtained.

In S102, each of the at least one sub-image is input to a multi-path neural network, and each sub-image is restored by using a restoration network determined for each sub-image to obtain and output a restored image of each sub-image, and obtaining a restored image of the acquired image based on the obtained restored image of each sub-image.

After at least one sub-image is acquired, in order to restore each of the at least one sub-image, each sub-image may be sequentially input to the multi-path neural network. In the multi-path neural network, the restoration network is determined for each sub-image. Each sub-image is restored by using the restoration network determined for each sub-image, and the restored image of each sub-image is output and obtained from the multi-path neural network. Finally, the restored images of all sub-images are spliced to obtain the restored image of the acquired image.

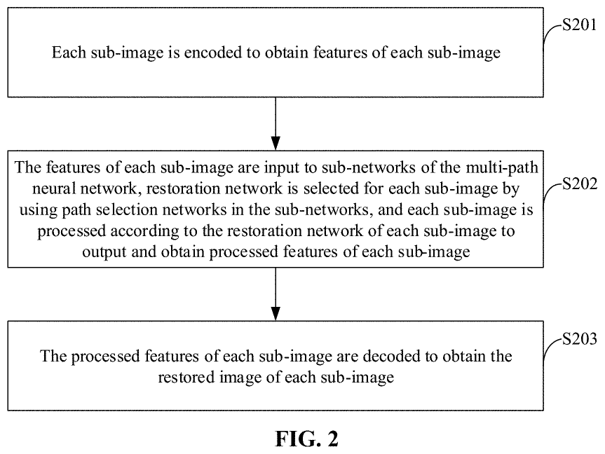

In order to obtain the restored image of each sub-image by inputting each sub-image to the multi-path neural network, in an optional embodiment, FIG. 2 is a flowchart schematic diagram of another method for image restoration according to an embodiment of the present disclosure. As shown in FIG. 2, S102 may include the following operations.

In S201, each sub-image is encoded to obtain features of each sub-image.

In S202, the features of each sub-image are input to sub-networks of the multi-path neural network, a restoration network is selected for each sub-image by using path selection networks in the sub-networks, and each sub-image is processed according to the restoration network of each sub-image to obtain and output processed features of each sub-image.

In S203, the processed features of each sub-image are decoded to obtain the restored image of each sub-image.

Specifically, the multi-path neural network includes three processing portions. The first processing portion is to encode each sub-image, which may be implemented by an encoder. For instance, the sub-image is a color image region, and may be represented as a tensor of 63*63*3. After the sub-image is encoded by an encoder, features of the sub-image are output and obtained, and may be represented as a tensor of 63*63*64.

In this way, each sub-image is first encoded in the multi-path neural network to obtain the features of the sub-image.

The second processing portion is to input the features of each sub-image to the sub-networks of the multi-path neural network. The sub-networks may be dynamic blocks correspondingly. The number of the dynamic blocks may be N, N being a positive integer greater than or equal to 1. In other words, the sub-networks may be one dynamic block, or may also be two or more dynamic blocks, which is not specifically limited in the embodiment of the present disclosure.

Each dynamic block includes a pathfinder (equivalent to the path selection network as described above), configured to determine the restoration network for each sub-image, such that each image may be processed in different dynamic blocks by adoption of a different restoration network. Therefore, the purpose of selecting different processing manners for different sub-images is achieved; and the obtained processed features are a tensor of 63*63*64.

The third processing portion is to decode each sub-image. After the processed features of each sub-image are obtained, the processed features of each sub-image are decoded, which may be implemented by a decoder herein. For instance, the above processed features are decoded to obtain the restored image of the sub-image, and the restored image may be represented as a tensor of 63*63*3.

In order to implement the processing on the features of the sub-images in the sub-networks of the multi-path neural network, in an optional embodiment, S202 may include the following operations.

When the number of sub-networks is N and the N sub-networks are sequentially connected to each other,

an i-th level of features of each sub-image are input to an i-th sub-network, and an i-th restoration network is selected for each sub-image from M restoration networks in the i-th sub-network by using an i-th path selection network in the i-th sub-network.

According to the i-th restoration network, the i-th level of features of each sub-image are processed to output and obtain an (i+1)-th level of features of each sub-image.

The i is updated to i+1, and the method returns to iteratively execute the above operations that features of each sub-image are input to the i-th sub-network, and a restoration network is selected for each sub-image, and the features of each sub-image are processed according to the selected restoration network, until an N-th level of features of each sub-image are output and obtained.

The N-th level of features of each sub-image are determined as the processed features of each sub-image.

When i=1, the i-th level of features of each sub-image are the features of each sub-image.

The N is a positive integer not less than 1, the M is a positive integer not less than 2, and i is a positive integer, i is greater than or equal to 1 and i is less than or equal to N.

In a case that the sub-networks are dynamic blocks, when the multi-path neutral network includes N dynamic blocks and the N dynamic blocks are sequentially connected to each other, the obtained features of each sub-image are input to the first dynamic block. Each dynamic block includes a pathfinder, a shared path and M dynamic paths.

Upon receiving features of a sub-image, the first dynamic block takes the received features of the sub-image as the first level of features of the sub-image; the first pathfinder determines the first restoration network for the sub-image from M dynamic paths according to the first level of features of the sub-image, such that a shared path and a dynamic path that is selected from the M dynamic paths constitute the first restoration network. Then, the first level of features of the sub-image are processed according to the first level of restoration networks to obtain the second level of features of the sub-image. Then i is updated as 2, the second level of features of the sub-image are input to the second dynamic block, and the third level of features of the sub-image are obtained according to the same processing method as that for the first dynamic block; and so on until the N-th level of features of the sub-image are obtained, thereby obtaining the processed feature of each sub-image.

In the multi-path neutral network, both the size of each feature of the sub-image and the number of restoration networks are variable. In actual applications, the size of the feature of the sub-image may have a tensor of 63*63*64, or may also have a tensor of 32*32*16, the tensor of 96*96*48, etc. The number N of dynamic blocks and the number M of dynamic paths are variable, for example, N=6, M=2; N=5, M=4, which is not specifically limited in the embodiment of the present disclosure.

Herein, it is to be noted that when the distortion problem to be solved is complex during selection of the parameters N and M as described above, both the N and the M may be increased appropriately; or otherwise, the N and the M may be decreased.

The structure for the shared path and the (2−M)-th dynamic path is not limited to a residual block, or may also be a dense block or another structure.

It is to be noted that the network structure of the pathfinder in each dynamic block may be identical, or may also be different, which is not specifically limited in the embodiment of the present disclosure.

In actual applications, the input of the pathfinder is a tensor of 63*63*64, and the output is a serial number aᵢ of the selected path; and the structure of the path selector, from input to output, respectively includes C convolutional layers, a fully connected layer (where the output dimension is 32), a Long-Short Term Memory (LSTM) module (the number of states is 32) and a fully connected layer (where the output dimension is M). The activation function for the last layer is Softmax or Rectified Linear Unit (ReLU); and the serial number of the maximum element in the activated M-dimensional vector is the serial number of the selected dynamic path.

The number of C may be adjusted according to the difficulty of the restoration tasks; and the output dimension of the first fully connected layer and the number of states of the LSTM module are not limited to 32, and may also be 16, 64, etc.

In order to update the parameters in the multi-path neutral network, in an optional embodiment, when the number of obtained restored images of the sub-images is greater than or equal to a preset number, the method may further include the following operations.

Restored images of the preset number of sub-images are acquired, and reference images corresponding to the restored images of the preset number of sub-images are acquired.

Based on the restored images of the preset number of sub-images and the corresponding reference images, networks except for the path selection networks in the multi-path neutral network are trained by an optimizer according to a loss function between the restored images of the preset number of sub-images and the corresponding reference images, and parameters of the networks except for the path selection networks in the multi-path neutral network are updated.

Based on the restored images of the preset number of sub-images and the corresponding reference images, the path selection networks are trained by the optimizer by use of a reinforcement learning algorithm according to a preset reward function, and parameters of the path selection networks are updated.

Specifically, the reference images are pre-stored, for example, the preset number of the reference images is 32. After restored images of the 32 sub-images are obtained, by taking the restored images of the 32 sub-images and their corresponding reference images as samples, based on the sample data, the networks except for the path selection networks in the multi-path neutral network are trained by using the optimizer according to the loss function between the restored images of the sub-images and the corresponding reference images, and the parameters of the networks except for the path selection networks in the multi-path neutral network are updated.

At the meantime, the restored images of the 32 sub-images and the corresponding reference images are still taken as the samples. In order to train the path selection networks, a reinforcement learning algorithm is used herein. For use of the reinforcement learning algorithm, reward functions are preset, and the optimization objective of the reinforcement learning algorithm is to maximize an expectation of a sum of all reward functions. Therefore, based on the sample data, according to the preset reward functions, the path selection networks are trained by the optimizer by use of the reinforcement learning algorithm, thereby updating the parameters of the path selection networks.

In other words, the networks except for the path selection networks in the multi-path neutral network, and the path selection networks are trained simultaneously in different processing manners to update the parameters of the networks.

A loss function between the restored images of the sub-images and the corresponding reference images are preset. The loss function may be L2 loss function, and may also be Visual Geometry Group (VGG) loss function, which is not specifically limited in the embodiment of the present disclosure.

In order to better update the parameters of the networks except for the path selection networks in the multi-path neutral network, in an optional embodiment, after the restored images of the preset number of sub-images are acquired and the reference images corresponding to the restored images of the preset number of sub-images are acquired, and before the networks except for the path selection networks in the multi-path neutral network are trained by the optimizer according to the loss function between the obtained restored images of the preset number of sub-images and the corresponding reference images, and the parameters of the networks except for the path selection networks in the multi-path neutral network are updated, the method may further include the following operation.

Based on the restored images of the preset number of sub-images and the corresponding reference images, the networks except for the path selection networks in the multi-path neutral network are trained by the optimizer according to the loss function between the restored images of the preset number of sub-images and the corresponding reference images, and the parameters of the networks except for the path selection networks in the multi-path neutral network are updated.

In other words, before the networks except for the path selection networks in the multi-path neutral network, and the path selection networks are simultaneously trained in different processing manners, the networks except for the path selection networks in the multi-path neutral network may be first trained based on the samples. Then, the networks except for the path selection networks in the multi-path neutral network, and the path selection networks are simultaneously trained in different processing manners. In this way, the parameters of the networks except for the path selection networks in the multi-path neutral network, and the path selection networks may be better optimized.

In an optional embodiment, the reward function is as shown in the formula (1):

$${r}_{i} = \{ \begin{matrix}- p ( 1 - {1}_{\{ 1 \}} ( {a}_{i} ) ) , & 1 \leq i \leq N \\ - p ( 1 - {1}_{\{ 1 \}} ( {a}_{i} ) ) + d , & i = N\end{matrix} \qquad ( 1 )$$

where rᵢ is a reward function for an i-th level of sub-networks, p is a preset penalty, 1_{{1}}(aᵢ) is an indicator function, and d is a coefficient of difficulty.

When aᵢ=1, the value of the indicator function is 1, and when aᵢ≠1, the value of the indicator function is 0.

The penalty is a set value. The value of the penalty is associated with the degree of distortion of the sub-image, and represents complexity of the network. When aᵢ=1, i.e., a simple connection path is selected, the penalty is 0 because no additional computation overhead is introduced. When aᵢ≠1, i.e., one complex path is selected, the reward function has a penalty (deduced by p).

The reward function is a reward function based on a coefficient of difficulty of the sub-image. The coefficient of difficulty may be a constant 1, or may also be a value associated with the loss function, which is not be specifically limited in the embodiment of the present disclosure.

Herein, when the coefficient of difficulty is the value associated with the loss function, in an optional embodiment, the coefficient of difficulty d is as shown in the formula (2):

$$d = \{ \begin{matrix}{L}_{d} / {L}_{0} , & 0 \leq {L}_{d} \leq {L}_{0} \\ 1 , & {L}_{d} \geq {L}_{0}\end{matrix} \qquad ( 2 )$$

Where, L_{d} represents a loss function between the restored images of the preset sub-images and the corresponding reference images, and L₀ is a threshold.

The above loss function may be mean-square error L2 loss function, or may also be VGG loss function, which is not be specifically limited in the embodiment of the present disclosure.

It is to be noted that the form of the loss function used in the coefficient of difficulty may be the same as that of the loss function used in the network training, or may also be different from that of the loss function used in the network training, which is not be specifically limited in the embodiment of the present disclosure.

For example, when the coefficient of difficulty is the independent variable and is a distance L2 between the restored image of the sub-image and the corresponding reference image, where L2 represents restoration effect; and the value of the distance becomes larger as the restoration effect is better, and thus the reward function is larger. The coefficient of difficulty d represents difficulty of restoration of one image region. The larger the difficulty is, the larger the value of d will be, which encourages that the network performs finer restoration on the region; and the less the difficulty is, the less the value of the d will be, and it is not advocated that the network performs excessively fine restoration on the region.

Examples are given below to illustrate the method for image restoration in the above one or more embodiments.

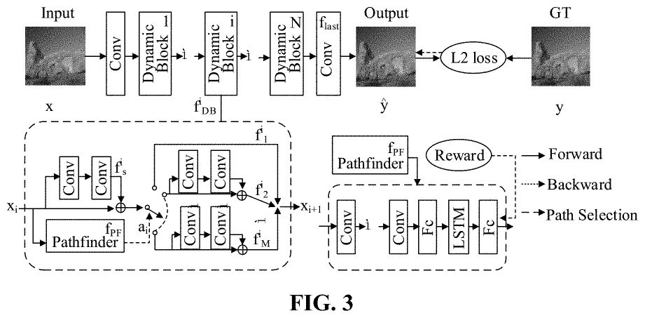

FIG. 3 is a structural schematic diagram of an optional multi-path neutral network according to an embodiment of the present disclosure. As shown in FIG. 3, an image is acquired, region division is performed on the image to obtain multiple sub-images x, the sub-images x (denoted by the tensor of 63*63*3) are input to an encoder of the multi-path neutral network, the encoder being a convolutional layer Conv. The sub-images x are encoded by the convolutional layer to obtain features of the sub-images x (denoted by the tensor of 63*63*64).

Then, the features of the sub-images x are input to the first dynamic block that includes the number of N dynamic blocks (Dynamic Block 1 . . . Dynamic Block i . . . Dynamic Block N). As can be seen from FIG. 3, each dynamic block includes a shared path ƒₛⁱ, a pathfinder ƒ_{PF} and M dynamic paths ƒ₁ⁱ, ƒ₂ⁱ, . . . ƒ_{M}ⁱ. For the first dynamic block, the first level of features x₁ of the sub-images is received, and the pathfinder processes the x₁ to obtain a₁. In the embodiment, the a₁ may select ƒ₁ⁱ. One dynamic path is determined for the x₁ from the M dynamic paths by the a₁, and the shared path and the dynamic path determined by the a₁ constitute a restoration network to process x₁, so as to obtain the first level of features x₂ of the sub-images. The features x₂ are input to the second level of dynamic blocks; and with the same processing as the x₁, x₃ is obtained, and so on until xₙ is obtained to serve as the processed features of the sub-images.

At last, the xₙ is input to a decoder, and the decoder is the convolutional layer Conv. By decoding the xₙ with the convolutional layer Conv, the restored images of the sub-images (represented by the tensor of 63*63*64, and as illustrated by the picture below output in FIG. 3) are obtained.

The input of the pathfinder is the tensor of 63*63*64, and the output is a serial number aᵢ of the selected path. As shown in FIG. 3, the structure of the path selector, from the input to output, respectively includes C convolutional layers (Conv 1 to Conv C), a fully connected layer FC (where the output dimension is 32), an LSTM module (where the number of states is 32) and a fully connected layer FC (where the output dimension is M). The activation function for the last layer is Softmax or Rectified Linear Unit (ReLU); and the serial number of the maximum element in the activated M-dimensional vector is the serial number of the selected dynamic path.

If the preset number is 32, after the restored images of the 32 sub-images are obtained, reference images corresponding to the 32 sub-images are first acquired from reference images GT (represented by y) to obtain a training sample. Then, according to the loss function L2 loss between the restored images of the preset number of sub-images and the reference images, networks except for the pathfinders in FIG. 3 are trained by using optimizer Adam, to update parameters of the network except for the path finders, thereby achieving optimization of network parameters.

Meanwhile, based on the above training sample, according to a preset reward function Reward associated with the coefficient of difficulty, the pathfinder in FIG. 3 is also trained by the optimizer Adam using a reinforcement learning algorithm, to update parameters of the pathfinder, thereby achieving optimization of the network parameters.

The algorithm used by the optimizer may be Stochastic Gradient Descent (SGD). The reinforcement learning algorithm may be REINFORCE, or may also be other algorithms such as actor-critic, which is not specifically limited in the embodiment of the present disclosure.

It is to be noted that the solid arrow in FIG. 3 represents Forward, the short dotted arrow represents Backward, and the long dotted arrow represents Path Selection.

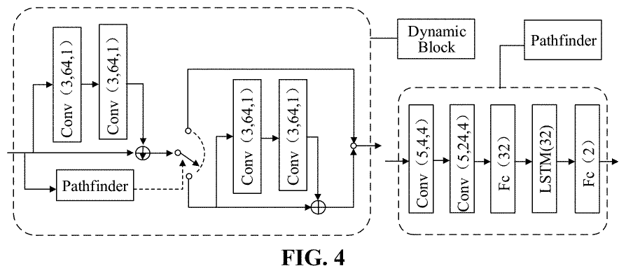

FIG. 4 is a structural schematic diagram of an optional dynamic block according to an embodiment of the present disclosure. As shown in FIG. 4, the dynamic block includes a shared path. The shared path is composed of two convolutional layers (two Conv (3, 64, 1)), a pathfinder and two dynamic paths. One of the dynamic paths has the same input and output, i.e., the features of the sub-images are not processed on the dynamic path; and the other dynamic path is provided with two convolutional layers (two Conv (3, 64, 1)), and the result of the pathfinder is synthesized by the shared path and the dynamic path. The pathfinder includes two convolutional layers (Conv (5, 4, 4) and Conv (5, 24, 4)), a fully connected layer Fc (32), an LSTM (32) and an Fc (32).

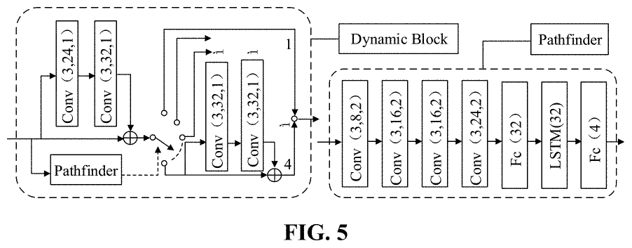

FIG. 5 is a structural schematic diagram of another optional dynamic block according to an embodiment of the present disclosure. As shown in FIG. 5, the dynamic block includes a shared path. The shared path is composed of two convolutional layers (Conv (3, 24, 1) and Conv (3, 32, 1)), a pathfinder and four dynamic paths. One dynamic path has the same input and output, i.e., the features of the sub-images are not processed on the dynamic path; and one dynamic path is provided with two convolutional layers (two Conv (3, 32, 1)), and the result of the pathfinder is synthesized by the shared path and the dynamic path. The pathfinder includes four convolutional layers (one Conv (3, 8, 2), two Conv (3, 16, 2) and one Conv (3, 24, 2)), a fully connected layer Fc (32), an LSTM (32) and an Fc (32).

By means of the above embodiments, the degraded image containing single or more distortions can be restored, and the distortions include but not limited to one or more of: Gaussian noise, Gaussian blur and Joint Photographic Experts Group (JPEG) compression. In the embodiment of the present disclosure, the speed may be increased by 4 times while achieving the same image restoration effect, and the specific proportion of speed-up is associated with the restoration tasks, where the speed-up becomes faster as the restoration task is more complex. Therefore, a better restoration effect is achieved under the premise of the same computational burden, and the restoration effect may be evaluated by a Peak Signal to Noise Ratio (PSNR) and a Structural Similarity Index (S SIM).

In addition, the present disclosure may quickly improve the image quality of pictures in the mobile phones, which includes removing or weakening the exposure noise, on-blur obscureness, compression distortion, etc. The content of a picture of the mobile phone can be various, and may have a larger portion of smooth sky region or virtualized background, which can be easily processed and quickly restored by the embodiment of the present disclosure. In this case, the computational burden is mainly focus on the main body region of the picture, thereby implementing image restoration in a sound and good manner.

According to the method and apparatus for image restoration, electronic device and storage medium according to the embodiments of the present disclosure, the apparatus for image restoration performs region division on an acquired image to obtain at least one sub-image, inputs each of the at least one sub-image to the multi-path neutral network, and restores each sub-image by using a restoration network determined for each sub-image to output and obtain a restored image of each sub-image, thereby obtaining the restored image of the acquired image. That is, in the technical solutions provided by the embodiments of the present disclosure, the region division is first performed on the acquired image to obtain at least one sub-image, each sub-image is then input to the multi-path neutral network, and each sub-image is restored by using the restoration network determined for each sub-image. Hence, the corresponding restoration network is determined for each sub-image in the multi-path neutral network, such that the restoration network used by each sub-image is not all the same, but instead different restoration networks are used for different sub-images. By using different restoration networks for different sub-images for restoration, some sub-images may be restored in a simple manner, and some sub-images are restored in a complex manner. Therefore, adoption of such region-customized image restoration method reduces the complexity of image restoration, thereby improving the speed of image restoration.

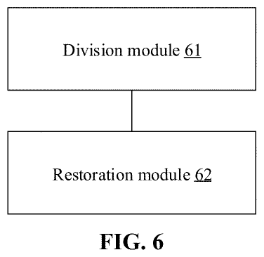

FIG. 6 is a structural schematic diagram of an apparatus for image restoration according to an embodiment of the present disclosure. As shown in FIG. 6, the apparatus for image restoration may include: a division module 61 and a restoration module 62.

The division module 61 is configured to perform region division on an acquired image to obtain at least one sub-image.

The restoration module 62 is configured to input each of the at least one sub-image to a multi-path neural network, and restore each sub-image by using a restoration network determined for each sub-image to obtain and output a restored image of each sub-image, thereby obtaining a restored image of the acquired image.

In some examples, the restoration module 62 may include: an encoding sub-module, a restoration sub-module and a decoding sub-module.

The encoding sub-module is configured to encode each sub-image to obtain features of each sub-image.

The restoration sub-module is configured to input the features of each sub-image to sub-networks of the multi-path neural network, select a restoration network for each sub-image by using path selection networks in the sub-networks, and process each sub-image according to the restoration network of each sub-image to output and obtain processed features of each sub-image.

The decoding sub-module is configured to decode the processed features of each sub-image to obtain the restored image of each sub-image.

In some examples, the restoration sub-module is specifically configured to:

when the number of sub-networks is N and the N sub-networks are sequentially connected to each other,

input an i-th level of features of each sub-image to an i-th sub-network, and select an i-th restoration network for each sub-image from M restoration networks in the i-th sub-network by using an i-th path selection network in the i-th sub-network;

process, according to the i-th restoration network, the i-th level of features of each sub-image to obtain and output an (i+1)-th level of features of each sub-image;

update the i to i+1, and iteratively execute the above operations of inputting the features of each sub-image, selecting a corresponding restoration network for each sub-image, and processing the features of each sub-image according to the selected restoration network, until an N-th level of features of each sub-image are output and obtained; and

determine the N-th level of features of each sub-image as the processed features of each sub-image.

When i=1, the i-th level of features of each sub-image are the features of each sub-image.

The N is a positive integer not less than 1, M is a positive integer not less than 2, and i is a positive integer greater than or equal to 1 and less than or equal to N.

In some examples, when the number of obtained restored images of the sub-images is greater than or equal to a preset number, the apparatus may further include: an acquisition module and a first training module.

The acquisition module is configured to acquire restored images of the preset number of sub-images, and acquire reference images corresponding to the restored images of the preset number of sub-images.

The first training module is configured to:

train, based on the restored images of the preset number of sub-images and the corresponding reference images, networks except for the path selection networks in the multi-path neutral network by an optimizer according to the loss function between the restored images of the preset number of sub-images and the corresponding reference images, and update parameters of the networks except for the path selection networks in the multi-path neutral network; and

train, based on the restored images of the preset number of sub-images and the corresponding reference images, the path selection networks by the optimizer by use of a reinforcement learning algorithm according to preset reward functions, and update parameters of the path selection networks.

In some examples, the apparatus may further include: a second training module.

The second training module is configured to:

after the restored images of the preset number of sub-images are acquired and the reference images corresponding to the restored images of the preset number of sub-images are acquired, and before the networks except for the path selection networks in the multi-path neutral network are trained by the optimizer according to the loss functions between the obtained restored images of the preset number of sub-images and the corresponding reference images, and update the parameters of the networks except for the path selection networks in the multi-path neutral network, train, based on the restored images of the preset number of sub-images and the corresponding reference images, the networks except for the path selection networks in the multi-path neutral network by the optimizer according to the loss functions between the restored images of the preset number of sub-images and the corresponding reference images, and update the parameters except for the path selection networks in the multi-path neutral network.

In some examples, the reward function is as shown in the formula (1):

$${r}_{i} = \{ \begin{matrix}- p ( 1 - {1}_{\{ 1 \}} ( {a}_{i} ) ) , & 1 \leq i \leq N \\ - p ( 1 - {1}_{\{ 1 \}} ( {a}_{i} ) ) + d , & i = N\end{matrix} \qquad ( 1 )$$

where rᵢ is a reward function of the i-th level of sub-networks, p is a preset penalty, 1_{{1}}(aᵢ) is an indicator function, and d is a coefficient of difficulty.

When aᵢ=1, the value of the indicator function is 1, and when aᵢ≠1, the value of the indicator function is 0.

In some examples, the coefficient of difficulty d is as shown in the formula (2):

$$d = \{ \begin{matrix}{L}_{d} / {L}_{0} , & 0 \leq {L}_{d} \leq {L}_{0} \\ 1 , & {L}_{d} \geq {L}_{0}\end{matrix} \qquad ( 2 )$$

where L_{d} is the loss function between the restored images of the preset sub-images and the corresponding reference images, and L₀ is a threshold.

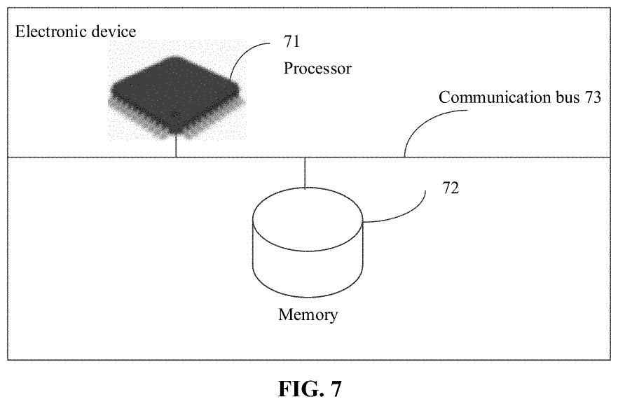

FIG. 7 is a structural schematic diagram of an electronic device according to an embodiment of the present disclosure. As shown in FIG. 7, the electronic device may include: a processor 71, a memory 72, and a communication bus 73.

The communication bus 73 is configured to implement connection and communication between the processor 71 and the memory 72.

The processor 71 is configured to execute an image restoration program stored in the memory 72 to implement the method for image restoration as described above.

An embodiment of the present disclosure further provides a computer readable storage medium, which stores one or more programs; and the one or more programs may be executed by one or more processors to implement the method for image restoration as described above. The computer readable storage medium may be a transitory memory such as a Random-Access Memory (RAM), or a non-transitory memory such as a Read-Only Memory (ROM), a flash memory, a Hard Disk Drive (HDD) or a Solid-State Drive (SSD), or may be a device including any one or combination of the above memories, such as a mobile phone, a computer, a tablet and a Personal Digital Assistant (PDA).

Those skilled in the art should understand that the embodiments of the present disclosure can provide a method, a system or a computer program product. Thus, the present disclosure can take the form of hardware embodiments, software embodiments or software-hardware combined embodiments. Moreover, the present disclosure can take the form of the computer program product implemented on one or more computer available storage media (including, but not limited to disk memory, optical memory etc.) containing computer-usable program codes.

The present disclosure is described with reference to flowcharts and/or block diagrams of the method, apparatus (system) and computer program product according to the embodiments of the present disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions designated by one or more processes in a flowchart and/or one or more blocks in a block diagram is generated via instructions executed by the computers or the processors of the other programmable data processing devices.

These computer program instructions can also be stored in a computer readable memory capable of guiding the computers or the other programmable data processing devices to operate in a specific manner, so that the instructions stored in the computer readable memory product an article of manufacture including an instruction apparatus, and the instruction apparatus realizes the functions designated by one or more processes in a flowchart and/or one or more blocks in a block diagram.

These computer program instructions can also be loaded on computers or other programmable data processing devices so as to carry out a series of operation operations on the computers or other programmable devices to generate the process to be achieved by the computer, so that the instructions executed by the computers or other programmable devices provide steps for implementing the functions designated by one or more processes in a flowchart and/or one or more blocks in a block diagram.

The above are merely preferred embodiments of the present disclosure, and are not intended to limit the protective scope of the present disclosure.

1. A method for image restoration, comprising:
performing region division on an acquired image to obtain at least one sub-image; and
inputting each of the at least one sub-image to a multi-path neural network, and restoring each sub-image by using a restoration network determined for the sub-image to obtain and output a restored image of each sub-image; and
obtaining a restored image of the acquired image based on the restored image of each sub-image.

2. The method of claim 1, wherein inputting each of the at least one sub-image to the multi-path neural network, and restoring each sub-image by using the restoration network determined for the sub-image to obtain and output the restored image of each sub-image comprises:
encoding each sub-image to obtain features of the sub-image;
inputting the features of each sub-image to sub-networks of the multi-path neural network, selecting a restoration network for each sub-image by using path selection networks in the sub-networks, and processing, according to the restoration network of each sub-image, the sub-image to obtain and output processed features of the sub-image; and
decoding the processed features of each sub-image to obtain the restored image of the sub-image.

3. The method of claim 2, wherein inputting the features of each sub-image to the sub-networks of the multi-path neural network, selecting the restoration network for each sub-image by using the path selection networks in the sub-networks, and processing, according to the restoration network of each sub-image, the sub-image to obtain and output the processed features of the sub-image comprises:
when a number of the sub-networks is N and the N sub-networks are sequentially connected,
inputting an i-th level of features of each sub-image to an i-th sub-network, and selecting an i-th restoration network for each sub-image from M restoration networks in the i-th sub-network by using an i-th path selection network in the i-th sub-network;
processing, according to the i-th restoration network, the i-th level of features of each sub-image to obtain an (i+1)-th level of features of the sub-image;
updating the i to i+1, and iteratively executing the operations of inputting features of each sub-image, selecting a restoration network, and processing the features of each sub-image according to the selected restoration network, until an N-th level of features of each sub-image are obtained; and
determining the N-th level of features of each sub-image as the processed features of the sub-image,
wherein when i=1, the i-th level of features of each sub-image are the features of the sub-image, and
wherein the N is a positive integer not less than 1, M is a positive integer not less than 2, and i is a positive integer, i is greater than or equal to 1 and i is less than or equal to N.

4. The method of claim 1, wherein when a number of obtained restored images of sub-images is greater than or equal to a preset number, the method further comprises:
acquiring restored images of the preset number of sub-images, and acquiring reference images corresponding to the restored images of the preset number of sub-images;
training, based on the restored images of the preset number of sub-images and the corresponding reference images, networks except for the path selection networks in the multi-path neutral network by an optimizer according to a preset loss function between the restored images of the preset number of sub-images and the corresponding reference images, and updating parameters of the networks except for the path selection networks in the multi-path neutral network; and
training, based on the restored images of the preset number of sub-images and the corresponding reference images, the path selection networks by the optimizer using a reinforcement learning algorithm according to a preset reward function, and updating parameters of the path selection networks.

5. The method of claim 4, wherein after acquiring the restored images of the preset number of sub-images and acquiring the reference images corresponding to the restored images of the preset number of sub-images, and before training the networks except for the path selection networks in the multi-path neutral network by the optimizer according to the loss function between the obtained restored images of the preset number of sub-images and the corresponding reference images, and updating the parameters of the networks except for the path selection networks in the multi-path neutral network, the method further comprises:
training, based on the restored images of the preset number of sub-images and the corresponding reference images, the networks except for the path selection networks in the multi-path neutral network by the optimizer according to the loss function between the restored images of the preset number of sub-images and the corresponding reference images, and updating parameters in the multi-path neutral network.

6. The method of claim 4, wherein the reward function is formulated as follows:
$${r}_{i} = \{ \begin{matrix}- p ( 1 - {1}_{\{ 1 \}} ( {a}_{i} ) ) , & 1 \leq i \leq N \\ - p ( 1 - {1}_{\{ 1 \}} ( {a}_{i} ) ) + d , & i = N\end{matrix}$$
where the rᵢ is a reward function for an i-th level of sub-networks, p is a preset penalty, 1_{{1}}(aᵢ) is an indicator function, and d is a coefficient of difficulty; and
when aᵢ=1, a value of the indicator function is 1, and when aᵢ≠1, the value of the indicator function is 0.

7. The method of claim 6, wherein the coefficient of difficulty d is formulated as follows:
$$d = \{ \begin{matrix}{L}_{d} / {L}_{0} , & 0 \leq {L}_{d} \leq {L}_{0} \\ 1 , & {L}_{d} \geq {L}_{0}\end{matrix}$$
where the L_{d} is the preset loss function between the restored images of the preset sub-images and the corresponding reference images, and L₀ is a threshold.

8. An electronic device, comprising: a processor, a memory and a communication bus, wherein
the communication bus is configured to implement connection and communication between the processor and the memory;
the memory is configured to store instruction an image restoration program executable by the processor; and
the processor is configured to:
perform region division on an acquired image to obtain at least one sub-image; and
input each of the at least one sub-image to a multi-path neural network, and restore each sub-image by using a restoration network determined for the sub-image to obtain and output a restored image of each sub-image; and
obtain a restored image of the acquired image based on the restored image of each sub-image.

9. The electronic device of claim 8, wherein the processor is further configured to:
encode each sub-image to obtain features of the sub-image;
input the features of each sub-image to sub-networks of the multi-path neural network, select a restoration network for each sub-image by using path selection networks in the sub-networks, and process, according to the restoration network of each sub-image, the sub-image to obtain and output processed features of the sub-image; and
decode the processed features of each sub-image to obtain the restored image of the sub-image.

10. The electronic device of claim 9, wherein the processor is further configured to:
when the number of sub-networks is N and the N sub-networks are sequentially connected,
input an i-th level of features of each sub-image to an i-th sub-network, and select an i-th restoration network for each sub-image from M restoration networks in the i-th sub-network by using an i-th path selection network in the i-th sub-network;
process, according to the i-th restoration network, the i-th level of features of each sub-image to obtain an (i+1)-th level of features of each sub-image;
update the i to i+1, and iteratively execute the operations of inputting features of each sub-image, selecting a restoration network, and processing the features of each sub-image according to the selected restoration network, until an N-th level of features of each sub-image are obtained; and
determine the N-th level of features of each sub-image as the processed features of the sub-image,
wherein when i=1, the i-th level of features of each sub-image are the features of the sub-image, and
wherein the N is a positive integer not less than 1, M is a positive integer not less than 2, and i is a positive integer, i is greater than or equal to 1 and i is less than or equal to N.

11. The electronic device of claim 8, wherein the processor is further configured to: when a number of obtained restored images of sub-images is greater than or equal to a preset number,
acquire restored images of the preset number of sub-images, and acquire reference images corresponding to the restored images of the preset number of sub-images;
train, based on the restored images of the preset number of sub-images and the corresponding reference images, networks except for the path selection networks in the multi-path neutral network by an optimizer according to a preset loss function between the restored images of the preset number of sub-images and the corresponding reference images, and update parameters of the networks except for the path selection networks in the multi-path neutral network; and
train, based on the restored images of the preset number of sub-images and the corresponding reference images, the path selection networks by the optimizer by use of a reinforcement learning algorithm according to a preset reward function, and update parameters of the path selection networks.

12. The electronic device of claim 11, wherein the processor is specifically configured to:
after the restored images of the preset number of sub-images are acquired, and the reference images corresponding to the restored images of the preset number of sub-images are acquired, and before the networks except for the path selection networks in the multi-path neutral network are trained by the optimizer according to the loss function between the obtained restored images of the preset number of sub-images and the corresponding reference images, and the parameters of the networks except for the path selection networks in the multi-path neutral network are updated,
train, based on the restored images of the preset number of sub-images and the corresponding reference images, the networks except for the path selection networks in the multi-path neutral network by the optimizer according to the loss function between the restored images of the preset number of sub-images and the corresponding reference images, and update the parameters except for the path selection networks in the multi-path neutral network.

13. The electronic device of claim 11, wherein the reward function is formulated as follows:
$${r}_{i} = \{ \begin{matrix}- p ( 1 - {1}_{\{ 1 \}} ( {a}_{i} ) ) , & 1 \leq i \leq N \\ - p ( 1 - {1}_{\{ 1 \}} ( {a}_{i} ) ) + d , & i = N\end{matrix}$$
where the rᵢ is a reward function for an i-th level of sub-networks, p is a preset penalty, 1_{{1}}(a₁) is an indicator function, and d is a coefficient of difficulty; and
when aᵢ=1, a value of the indicator function is 1, and when aᵢ≠1, the value of the indicator function is 0.

14. The electronic device of claim 13, wherein the coefficient of difficulty d is formulated as follows:
$$d = \{ \begin{matrix}{L}_{d} / {L}_{0} , & 0 \leq {L}_{d} \leq {L}_{0} \\ 1 , & {L}_{d} \geq {L}_{0}\end{matrix}$$
where the L_{d} is the preset loss function between the restored images of the preset sub-images and the corresponding reference images, and L₀ is a threshold.

15. A non-transitory computer-readable storage medium, having stored therein one or more programs, wherein the one or more programs are capable of being executed by one or more processors to carry out:
performing region division on an acquired image to obtain at least one sub-image; and
inputting each of the at least one sub-image to a multi-path neural network, and restoring each sub-image by using a restoration network determined for the sub-image to obtain and output a restored image of each sub-image; and
obtaining a restored image of the acquired image based on the restored image of each sub-image.

16. The non-transitory computer-readable storage medium of claim 15, wherein inputting each of the at least one sub-image to the multi-path neural network, and restoring each sub-image by using the restoration network determined for the sub-image to obtain and output the restored image of each sub-image comprises:
encoding each sub-image to obtain features of the sub-image;
inputting the features of each sub-image to sub-networks of the multi-path neural network, selecting a restoration network for each sub-image by using path selection networks in the sub-networks, and processing, according to the restoration network of each sub-image, the sub-image to obtain and output processed features of the sub-image; and
decoding the processed features of each sub-image to obtain the restored image of the sub-image.

17. The non-transitory computer-readable storage medium of claim 16, wherein inputting the features of each sub-image to the sub-networks of the multi-path neural network, selecting the restoration network for each sub-image by using the path selection networks in the sub-networks, and processing, according to the restoration network of each sub-image, the sub-image to obtain and output the processed features of the sub-image comprises:
when a number of the sub-networks is N and the N sub-networks are sequentially connected,
inputting an i-th level of features of each sub-image to an i-th sub-network, and selecting an i-th restoration network for each sub-image from M restoration networks in the i-th sub-network by using an i-th path selection network in the i-th sub-network;
processing, according to the i-th restoration network, the i-th level of features of each sub-image to obtain an (i+1)-th level of features of the sub-image;
updating the i to i+1, and iteratively executing the operations of inputting features of each sub-image, selecting a restoration network and processing the features of each sub-image according to the selected restoration network, until an N-th level of features of each sub-image are obtained; and
determining the N-th level of features of each sub-image as the processed features of the sub-image,
wherein when i=1, the i-th level of features of each sub-image are the features of the sub-image, and
wherein the N is a positive integer not less than 1, M is a positive integer not less than 2, and i is a positive integer, i is greater than or equal to 1 and i is less than or equal to N.

18. The non-transitory computer-readable storage medium of claim 15, wherein the one or more programs are capable of being executed by one or more processors to further carry out:
when a number of obtained restored images of sub-images is greater than or equal to a preset number,
acquiring restored images of the preset number of sub-images, and acquiring reference images corresponding to the restored images of the preset number of sub-images;
training, based on the restored images of the preset number of sub-images and the corresponding reference images, networks except for the path selection networks in the multi-path neutral network by an optimizer according to a preset loss function between the restored images of the preset number of sub-images and the corresponding reference images, and updating parameters of the networks except for the path selection networks in the multi-path neutral network; and
training, based on the restored images of the preset number of sub-images and the corresponding reference images, the path selection networks by the optimizer using a reinforcement learning algorithm according to a preset reward function, and updating parameters of the path selection networks.

19. The non-transitory computer-readable storage medium of claim 18, wherein the one or more programs are capable of being executed by one or more processors to further carry out:
after acquiring the restored images of the preset number of sub-images and acquiring the reference images corresponding to the restored images of the preset number of sub-images, and before training the networks except for the path selection networks in the multi-path neutral network by the optimizer according to the loss function between the obtained restored images of the preset number of sub-images and the corresponding reference images, and updating the parameters of the networks except for the path selection networks in the multi-path neutral network,
training, based on the restored images of the preset number of sub-images and the corresponding reference images, the networks except for the path selection networks in the multi-path neutral network by the optimizer according to the loss function between the restored images of the preset number of sub-images and the corresponding reference images, and updating parameters in the multi-path neutral network.

20. The non-transitory computer-readable storage medium of claim 18, wherein the reward function is formulated as follows:
$${r}_{i} = \{ \begin{matrix}- p ( 1 - {1}_{\{ 1 \}} ( {a}_{i} ) ) , & 1 \leq i \leq N \\ - p ( 1 - {1}_{\{ 1 \}} ( {a}_{i} ) ) + d , & i = N\end{matrix}$$
where the rᵢ is a reward function for an i-th level of sub-networks, p is a preset penalty, 1_{{1}}(aᵢ) is an indicator function, and d is a coefficient of difficulty; and
when aᵢ=1, a value of the indicator function is 1, and when aᵢ≠1, the value of the indicator function is 0.
